(19) United States
(12) Patent Application Publication
(10) Pub. No.: US 2007/0009259 A1
(43) Pub. Date: Jan. 11, 2007

(54) Optical transmission system test apparatus

(76) Inventors: Predrag Dragovic, Howell, NJ (US); Dat D. Ngo, Howell, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/175,464

(22) Filed: Jul. 6, 2005

(51) Int. Cl. H04B 10/08

(52) U.S. Cl. 398/27

(57) ABSTRACT

An OSNR reducer adds a prescribed noise spectrum at a prescribed power level to an input optical signal. The OSNR reducer employs at least one optical amplifier to generate the noise and an optical combiner to combine the input optical signal with the noise. Optionally, the OSNR reducer may have a tunable filter that selects a desired wavelength range of the noise and a controller that varies the power level of the noise generated.

### TECHNICAL FIELD

This invention relates to the art of transmitting signals over fiber optic systems, and more particularly, to a test apparatus for simulating signals that are transmitted over optical fibers.

### BACKGROUND OF THE INVENTION

An optical signal to noise ratio (OSNR) provides a measure of the quality of an optical signal. The higher the OSNR, the better the signal power level is compared to the noise power level. When an optical signal traverses a non-amplified fiber span that is part of a link, the signal and noise degrade proportionally, so the OSNR remains substantially constant. However, when an optical signal is amplified by an optical amplifier, not only will the optical power of the signals increase, but the noise power level is also increased, and indeed, it is increased proportionally more so than the optical signal. More specifically, for example, when signals propagate through an erbium doped fiber amplifier (EDFA), noise from amplified spontaneous emission (ASE) is added to the signal while the signal is amplified. Thus, optical amplification results in a reduction of OSNR as each amplifier that a signal propagates through adds more noise to the signal it receives.

Low OSNR makes it more difficult for a receiver to properly distinguish the desired signal from the noise, and, as such, increases the likelihood that reception of the optical signal will not be essentially error-free. In other words, the bit error rate (BER) at the receiver tends to increase as OSNR decreases. However, receipt of an optical signal with a high BER is not acceptable.

One method to increase the length of a link in an optical system, such as a dense wavelength division multiplexing (DWDM) system, with error-free transmission is to perform an optical-to-electrical-to-optical (O-E-O) regeneration of a low OSNR version of the signal before the OSNR reaches a level such that the signal cannot be recovered error-free. The regenerated signal, which is essentially noise-free, is propagated further down the link in lieu of the low OSNR version of the signal. Unfortunately, employing O-E-O in a link is expensive.

Another method to achieve substantially error-free reception of the information needed to be conveyed error-free over the link is to employ Forward Error Correction (FEC). FEC is a technique in which a transmitter adds bits that are useful for error correction by a receiver to the information needed to be conveyed by the transmitter. The combined signal of information and additional bits are transmitted as the optical signal. A receiver employs the additional bits to correct for errors in the received optical bit stream, e.g., due to low OSNR, and to produce an essentially error-free version of the information that needed to be conveyed. This method allows for better reception at a much lower cost than would result from employing O-E-O.

### SUMMARY OF THE INVENTION

A current method of testing the efficiency of FEC is to attenuate the optical signal and any associated noise by passing the signal and associated noise through a variable optical attenuator (VOA). The recovered signal, after performance of FEC by the receiver, is compared with the original information signal that needed to be conveyed. Based on the comparison, the BER of the signal recovered after FEC is computed. The computed BER provides an indication of how well the FEC has corrected the raw bits received.

We have recognized that the VOA only simulates what an optical signal would experience by traversing a long span of fiber, in that it decreases the signal power level and the noise power level proportionally. As a result, unfortunately, the VOA does not reduce OSNR. In other words, the VOA does not simulate the experience of a signal traversing a DWDM link having one or more optical amplifiers, and, as such, the signal supplied to the receiver after passing through the VOA is not an accurate simulation of the actual entire DWDM span. Thus, disadvantageously, the VOA does not allow for accurate testing of FEC at the receiving end of the DWDM system.

The problems of the prior art in testing the quality of optical signals are overcome, in accordance with the principles of the invention, by more accurately simulating the conditions experienced by an optical signal traversing a link with optical amplification. This is achieved by an optical signal to noise ratio (OSNR) reducer that intentionally adds noise to an optical signal. The OSNR reducer need not attenuate the optical signal. The OSNR reducer need merely raise the noise level without otherwise changing the input optical signal, thereby decreasing the quality of the input optical signal, i.e., the OSNR decreases, thereby raising the BER of the input optical signal. Raising the BER of the input optical signal allows for more accurate testing of FEC code. Preferably, the spectrum, as well as the magnitude of the injected noise, should match as closely as possible the spectrum and magnitude of noise that actual optical amplifiers along a link would add in total to an optical signal traversing that link.

In one embodiment of the invention, the OSNR reducer employs one optical amplifier to generate noise, which has a prescribed spectrum. Typically, the spectrum of the noise depends on the characteristics of the particular amplifier employed to generate it. An optical combiner combines the noise output by the optical amplifier with an input optical information signal. This arrangement allows the OSNR reducer to simulate the noise generated and added to an optical signal by one optical amplifier or a chain of the same types of optical amplifiers along an optical fiber link.

In another embodiment of the invention, the OSNR reducer employs optical amplifiers of at least two different types. The outputs of each of the optical amplifiers are combined together by a first optical combiner so as to generate noise that is a composite of at least two different spectrums. The combined noise is supplied to a tunable filter that selects a specific wavelength range of the combined noise spectrum. The output of the tunable filter is combined with an input optical signal to be tested. This arrangement allows the OSNR reducer to simulate the noise that would be generated by a chain of different types of optical amplifiers along an optical fiber link.

Optionally, the OSNR reducer may have a controller that can supply a signal to control the level of noise generated by at least one of the optical amplifiers. The controller may be responsive to the input optical signal or the input optical signal with added noise. Also, optionally, to better simulate a real world environment, at least one adjustable optical attenuator may be added to the OSNR reducer, in order to allow simulation of loss by a fiber span before or after the point of noise addition.

In another embodiment of the invention, the OSNR reducer is interposed between a DWDM signal source and a DWDM receiver. In this arrangement, the optional controller for the OSNR reducer may work in conjunction with the DWDM receiver to monitor the received bit error rate, so that the bit error rate can be set to a target raw BER, which is the BER prior to performance of the FEC by the receiver.

### BRIEF DESCRIPTION OF THE DRAWINGS

FIG. 1 shows an exemplary optical signal to noise ratio (OSNR) reducer arranged in accordance with the principles of the invention;

FIG. 2 shows another exemplary OSNR reducer employing multiple optical amplifiers.;

FIG. 3 shows an exemplary use of an OSNR reducer in an arrangement for testing a DWDM system in accordance with the principles of the invention; and

FIG. 4 shows a flow chart for a method of operating an OSNR reducer.

### DETAILED DESCRIPTION

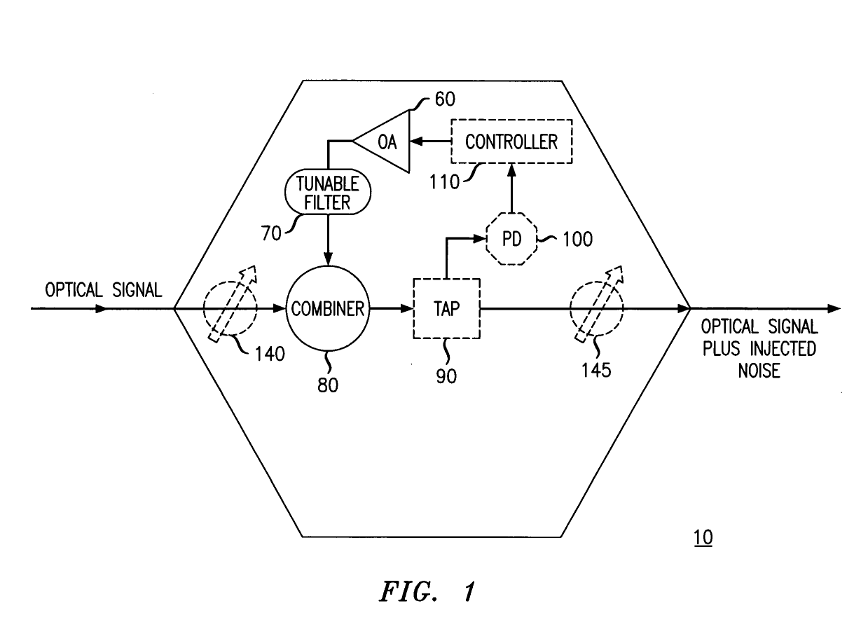

FIG. 1 shows an exemplary optical signal to noise ratio (OSNR) reducer 10 arranged in accordance with the principles of the invention. More particularly, shown in FIG. 1 are optical amplifier (OA) 60, tunable filter 70, optical combiner 80, optional tap 90, optional photo detector (PD) 100, optional controller 110, optional attenuator 140 and optional attenuator 145.

In one embodiment of the invention, optical amplifier 60 is an erbium doped fiber amplifier (EDFA) that is used to supply noise. The supplied noise typically has a spectrum that depends on the characteristics of the particular amplifier. For example, the noise may have substantially equal power at all wavelengths, which is referred to as white noise. More specifically, when optical amplifier 60 is not supplied with an input signal, it generates noise by amplified spontaneous emission (ASE). Such noise may exist in the wavelengths ranging from, for example, 1200 nm to 1620 nm.

The power level of the noise generated by optical amplifier 60 may be controlled by an input control signal, such as may be supplied by optional controller 110. For example, the signal supplied by optional controller 110 to optical amplifier 60 may vary a laser bias current in optical amplifier 60 that controls the amount of optical output power from optical amplifier 60. The level of noise may be varied so as to simulate the noise added by one or more optical amplifiers of the same type of optical amplifiers along an optical fiber link.

Tunable filter 70 receives as an input the noise generated by optical amplifier 60 and selects various desired wavelengths of the noise, e.g., wavelengths in the range of 1500 nm to 1550 nm, if only a subset of all of the wavelengths generated by optical amplifier 60 is desired. Tunable filter 70 need not be employed, for example, when it is desired to add the full range of noise wavelengths generated by optical amplifier 60. Note that it is also possible that an optical amplifier may have integrated within itself the function of tunable filter 70. Optionally, tunable filter 70 may further shape the power spectrum of the noise.

Optical combiner 80 combines a received input optical signal, e.g., one encoded with a Forward Error Correction (FEC) code that is to be tested, with the noise that is supplied as the output of tunable filter 70. The resulting combined signal is an output of optical combiner 80.

Optional tap 90 is an optical splitter that supplies a small portion of the combined signal power to an optional monitoring element, i.e., photo detector 100. The remainder of the combined signal power is supplied by tap 90 as an output for further use as described hereinbelow.

Optional photo detector 100 may receive a portion of the combined signal power from the output of optical combiner 80 via tap 90. Photo detector 100 converts the optical signal it receives to an electrical representation of the combined input optical signal and the added noise spectrum at a desired wavelength range, which is supplied as an output to controller 110.

OSNR reducer 10 may further include optional controller 110, which receives as an input the output of photo detector 100. Controller 110 may use the output of photo detector 100 to determine the amount of noise that OSNR reducer 10 is supplying to the combined signal. Controller 110 may send a signal to the control input of optical amplifier 60, based on the input from photo detector 100, to increase or decrease the power level of the noise generated by optical amplifier 60.

OSNR reducer 10 may further include an adjustable attenuator, which adjusts the power level of an optical signal to simulate the effect of a loss in power that an optical signal would experience when traversing through a length of fiber. Doing so may better simulate the conditions likely to be experienced by an optical signal in an actual optically amplified fiber optic communications system. For example, optional adjustable attenuator 140 may be connected to an input of optical combiner 80 so as to attenuate the input optical signal. Alternatively, optional adjustable attenuator 145 may be connected to an output of optical combiner 80 so as to attenuate the combined input optical signal plus noise from optical amplifier 60 before the combined signal is supplied to an optical receiver.

Advantageously, OSNR reducer 10 simulates the noise added to the optical signal propagating on an actual optical link by the optical amplifiers that are part of the link. Also, advantageously, OSNR reducer 10 at least increases the noise of the input optical signal. As a result, the quality of the optical signal decreases, i.e., OSNR decreases. Doing so may have the effect of raising the bit error rate (BER) of the optical signal at a receiver, allowing for the efficacy of any FEC coding to be more accurately tested.

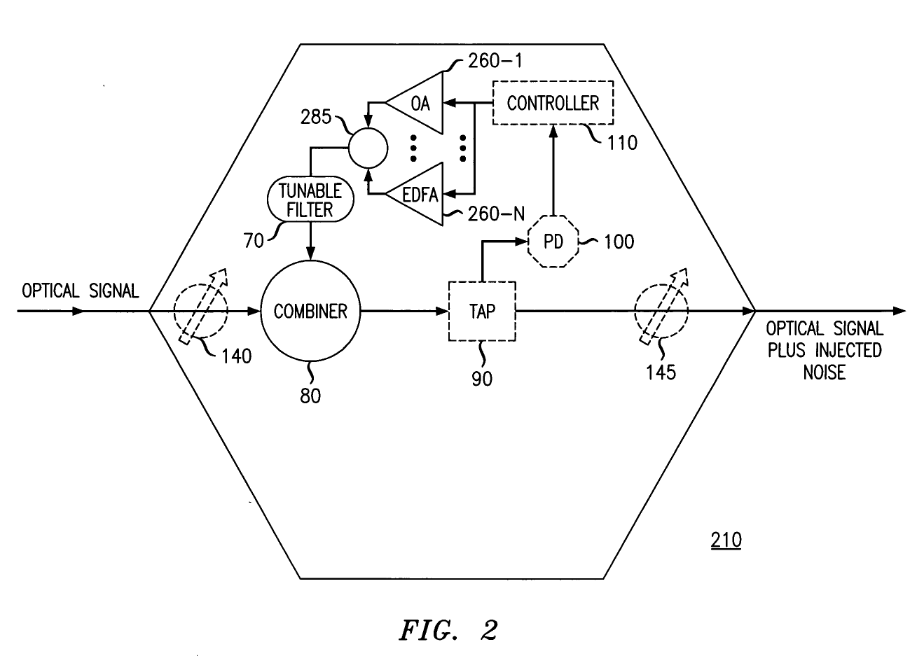

FIG. 2 shows another exemplary OSNR reducer arranged in accordance with the principles of the invention. Rather than employing a single optical amplifier as in FIG. 1, in FIG. 2, OSNR reducer 210 employs multiple optical amplifiers 260-1 to 260-N, collectively hereinafter optical amplifiers 260. Optical amplifiers 260 are optical amplifiers of at least two different types, so that each generates noise with different spectrums that may have the same or different magnitudes. This arrangement allows OSNR reducer 210 to simulate the noise spectrum generated by a chain of different types of optical amplifiers that may be encountered by an optical signal as it traverses an optical fiber link.

Optical combiner 285 combines the noise supplied by each of optical amplifiers 260 into a composite noise signal. The composite noise signal that is output by optical combiner 285 is supplied as an input to tunable filter 70. Tunable filter 70 selects a desired wavelength range of the composite noise signal. Optical combiner 80 combines a received input optical signal, e.g., one encoded with a Forward Error Correction (FEC) code that is to be tested, with the noise that is supplied as the output of tunable filter 70, and supplies the resulting combined signal as an output.

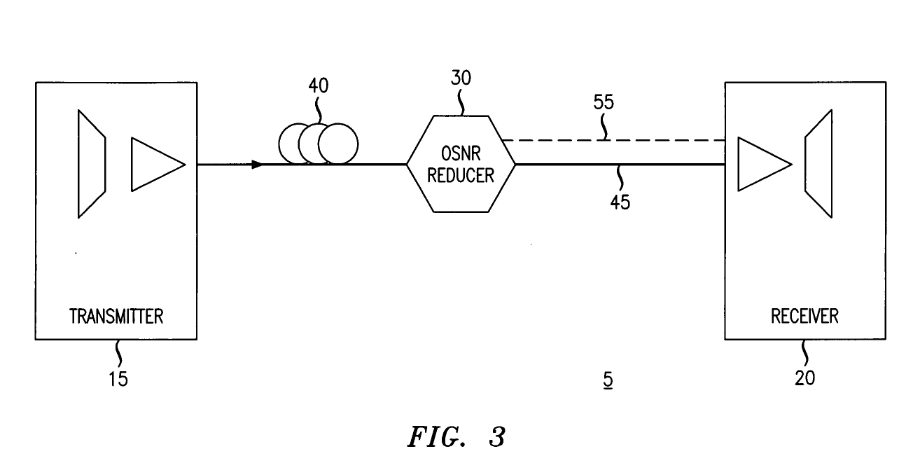

FIG. 3 shows an exemplary OSNR reducer arranged to test the combined operation of transmitter 15 and receiver 20 over simulated DWDM span 5. Shown in FIG. 3 are transmitter 15, OSNR reducer 30, optical fiber 40, receiver 20, and optical fiber 45. Transmitter 15, optical fiber 40, optical fiber 45, and receiver 20 may be conventional components and will not be discussed in detail.

In FIG. 3, optical fiber 40 carries signals generated by transmitter 15 to OSNR reducer 30. Similarly, optical fiber 45 carries signals generated by OSNR reducer 30 to receiver 20. Receiver 20 is connected to a controller within OSNR reducer 30, such as controller 110 (FIG. 1), over communication channel 55.

To measure the performance of a particular FEC code, an optical signal is transmitted through OSNR reducer 30 without FEC coding, and then the same optical signal is coded with a FEC and transmitted through OSNR reducer 30. A comparison of the results using the FEC and not using the FEC is made to determine how much of a reduction in bit error rate is provided by the FEC.

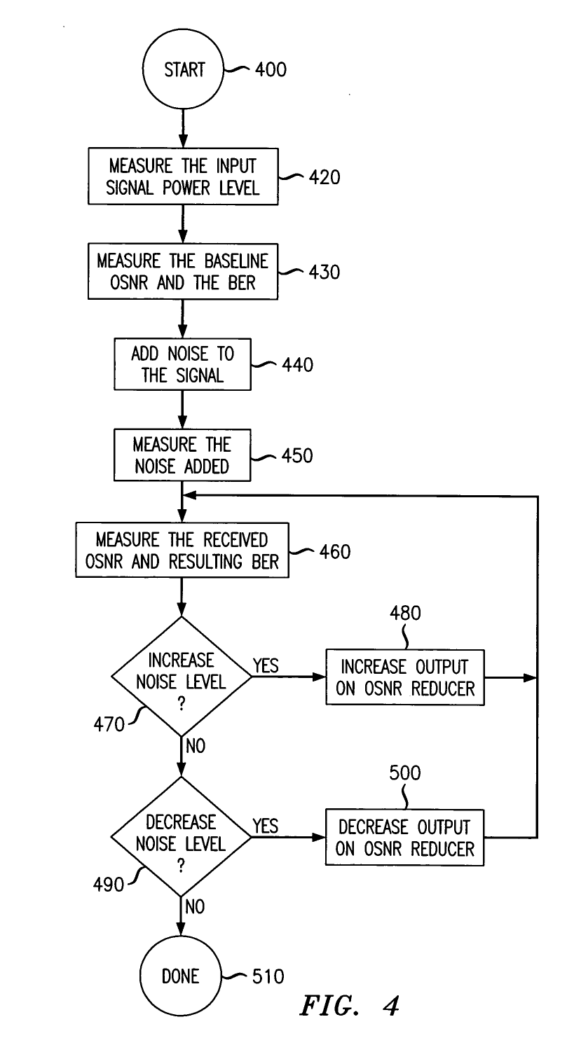

FIG. 4 shows a flow chart of an exemplary process for controlling the level of noise added by an OSNR reducer to an optical signal to achieve a target BER, and to determine the noise level that needs to be added to achieve the target BER. This way, for a particular transmit power, a system designer can know how much noise it is acceptable for the amplifiers in a link of an optical system to add and yet the signal received at the receiver of such a link will still achieve the target BER.

The process is entered in step 400 when a transmitter, e.g., transmitter 15 (FIG. 3), transmits an optical signal to be tested. Thereafter, in step 420, the power level of the optical signal before the OSNR reducer adds any noise to it is measured, e.g., by photo detector 100 (FIG. 1) in combination with controller 110. This is achieved by setting the noise level added by the OSNR reducer to zero. The OSNR and BER of the optical signal without added noise are measured, in step 430 (FIG. 4), by an optical receiver, e.g., receiver 20 (FIG. 3).

Note that BER may be computed using similar techniques to those employed by SONET. SONET-compliant transmission systems, which may be implemented using DWDM, may utilize a bit parity check mechanism for error detection. More specifically, the transmitter performs a bit parity calculation over a specified block in each SONET frame and inserts a result in a specified location within the frame structure, e.g., B1, B2, or B3 bytes. The receiver performs the bit parity calculation over a specified block of the frame and compares the result with the value encoded by the transmitter. The number of bits that are different between the receiver and transmitter bit interleaved parity (BIP) calculation represents the number of bit errors detected in a particular frame. BER is derived from the bit error count over an accumulation period.

Alternatively, a test set could supply the signal to be transmitted in electronic form to the transmitter. The receiver converts the signal it receives to electronic form and supplies the electronic version to the test set. The test set compares the signal it sent to the transmitter with that it received from the receiver and determines the BER. FEC coding and decoding may be done in the transmitter and receiver, respectively.

Next, in step 440 (FIG. 4), the OSNR reducer adds noise to the optical signal received from the transmitter and supplies the combined signal and noise to the receiver.

In step 450, the amount of noise added by the OSNR reducer is measured, e.g., by photo detector 100 (FIG. 1) in combination with controller 110. To this end, controller 110 determines the difference between the previously determined power level of the signal before the OSNR reducer added noise and the currently determined power level of the combined signal after the OSNR reducer added noise. This difference is the amount of noise contributed by the OSNR reducer. Furthermore, controller 110 may determine the OSNR of the combined signal and noise.

In step 460 (FIG. 4), the optical receiver measures the BER of the version of the optical signal and noise that it received via the optical fiber, e.g., optical fiber 45 (FIG. 3), from OSNR reducer 30, and it may determine the OSNR. If multiple frequencies are received, e.g., when the transmitter and receiver are suitable for using a DWDM system, step 460 is performed for at least one optical frequency.

The controller of the OSNR reducer may work in conjunction with the optical receiver to monitor the bit error rate of the optical signal at the receiver in order to produce a target bit error rate. The receiver may supply the current bit error rate to the OSNR reducer over a communication channel, e.g., communication channel 55 (FIG. 3), using any of several communication protocols, such as Simple Network Management Protocol (SNMP) and Transaction Language 1 (TL1). The controller of the OSNR reducer may be programmed to request the BER from the receiver. In response to the communicated bit error rate, the controller of the OSNR reducer may either a) display the bit error rate, so that a user can adjust the OSNR manually to achieve a desired bit error rate, or b) adjust the noise level automatically to achieve a pre-programmed target bit error rate.

At this point in the process it is necessary to determine whether to adjust, i.e., increase or decrease, the power level of the noise added to the optical signal. The power level of the noise added to the optical signal needs to be increased when the BER is lower than the target BER. Conversely, the power level of the noise added to the optical signal needs to be decreased when either 1) the receiver cannot recover the signal structure from the received combination of signal and noise because the noise has corrupted the signal structure beyond the receiver's ability to discern the structure or 2) the signal structure can be recovered but the BER is higher than the target BER.

If the test result in conditional branch point 470 (FIG. 4) is YES, indicating that the power level should be increased because the computed BER is less than the target BER, then control is passed to step 480. In step 480, the power level of the noise generated by the OSNR reducer is increased, e.g., controller 110 (FIG. 1) signals to optical amplifier 60 to increase the power level of the noise it is generating. Thereafter, control passes back to step 460 so that an OSNR and BER of the now modified with increased noise received optical signal may be measured. If the test result in step 470 (FIG. 4) is NO, indicating that the power level should either be reduced or remain as it is, then control is passed to conditional branch point 490.

If the test result in conditional branch point 490 is YES, indicating that the power level should be decreased because the noise level is too high, because either 1) the receiver cannot recover the signal structure from the received combination of signal and noise because the noise has corrupted the signal structure beyond the receiver's ability to discern the structure or 2) the signal structure can be recovered but the BER is higher than the target BER, control passes to step 500. In step 500, the power level of the noise generated by the OSNR reducer is decreased, e.g., controller 110 (FIG. 1) signals to optical amplifier 60 to decrease the power level of the noise it is generating. Thereafter, control passes back to step 460 so that an OSNR and BER of the now modified with reduced noise received optical signal are measured. If the test result in conditional branch point 490 (FIG. 4) is NO, indicating that the power level should remain as it is because the computed BER is equal to the target BER, the process is then exited in step 510. Optionally the power level of the noise that achieved the target BER may be presented to a user in a desired form by controller 110 (FIG. 1).

Note that the benefits of using FEC correction can be seen by setting a target bit rate and then repeating the process with and without the FEC correction being enabled for a particular information signal that needs to be conveyed from the transmitter to the receiver. Generally, when the FEC correction is enabled, the power level of the noise that achieves the target bit rate will be higher than when FEC correction is not enabled.

The foregoing merely illustrates the principles of the invention. It will thus be appreciated that those skilled in the art will be able to devise various arrangements, which, although not explicitly described or shown herein, embody the principles of the invention, and are included within its spirit and scope.

1. An apparatus operable to generate optical noise having a prescribed power level, and to supply as an output a combination of said noise with an optical signal received by said apparatus as an input.

2. The apparatus of claim 1 wherein said apparatus does not attenuate said optical signal.

3. The apparatus of claim 1 wherein said apparatus is operable to vary a power level of said noise as a function of said combined optical signal and generated noise.

4. The apparatus of claim 1 wherein said generated noise has a spectrum that is a composite of the spectrum of at least two noise sources.

5. The apparatus of claim 4 wherein said at least two noise sources have qualitatively different respective noise spectra.

6. The apparatus of claim 4 wherein said composite has a magnitude equal to the sum of the spectra of said at least two noise sources.

7. An apparatus comprising:
a first optical amplifier operable to generate noise; and
an optical combiner adapted to combine an input optical signal received at said optical combiner with said generated noise and to supply a combination of said input optical signal and said generated noise as an output.

8. The apparatus of claim 7 further comprising a tunable filter coupled between an output of said first optical amplifier and an input to said optical combiner, said tunable filter being operable to select a desired wavelength range of said generated noise, wherein said output of said optical combiner is a combination of said generated noise over said desired wavelength range and said input optical signal.

9. The apparatus of claim 8 further comprising a photo detector that receives a portion of said output of said optical combiner, said photo detector being coupled to an output of said optical combiner.

10. The apparatus of claim 7 wherein said first optical amplifier is an erbium doped fiber amplifier (EDFA).

11. The apparatus of claim 7 wherein said first optical amplifier is operable to generate said noise in a wavelength range of 1200 nm to 1620 nm.

12. The apparatus of claim 7 wherein said generated noise has a white spectrum over a wavelength range of interest.

13. The apparatus of claim 7 further comprising a controller coupled to an output of a photo detector that receives a portion of said combined input optical signal and generated noise.

14. The apparatus of claim 13 wherein said controller is operable to vary a power level of said generated noise as a function of said combined input optical signal and noise.

15. The apparatus of claim 13 wherein said controller is coupled to an optical receiver via a communication channel, and said received input optical signal is coded with a forward error correction (FEC) code.

16. The apparatus of claim 13 wherein said controller is operable to a) work in conjunction with said optical receiver to monitor a bit error rate (BER) of said received input optical signal and b) adjust said power level of said generated noise, so as to achieve a prescribed BER.

17. The apparatus of claim 7 further comprising an optical attenuator for attenuating the power level of said input optical signal and for supplying an attenuated version of said input optical signal to be said input optical signal received at said optical combiner.

18. The apparatus of claim 7 further comprising an optical attenuator coupled to said output of said optical combiner for attenuating the power level of said combination of said input optical signal and said generated noise.

19. The apparatus of claim 7 further comprising a second optical amplifier operable to generate additional noise, and wherein said optical combiner further combines said additional noise generated by said second optical amplifier with said noise generated by said first optical amplifier so that said output of said optical combiner is a combination of said noise generated by said first optical amplifier, said additional noise generated by said second optical amplifier and said input optical signal.

20. A method for operating an apparatus to modify a signal received by said apparatus as an input, the method comprising the steps of:
generating noise having a prescribed power level; and
combining said generated noise and said received signal to develop an output signal so that said generated noise increases the noise power of said output signal with respect to said received signal.

21. The method of claim 20 further comprising the step of monitoring errors in said output signal caused by said increase in noise power.

22. An apparatus comprising:
means for generating noise having a prescribed spectrum; and
means for combining said noise with a received signal to develop an output signal so that said generated noise increases the noise power of said output signal with respect to said received signal.

23. An amplified fiber link simulator that simulates the decrease in both 1) OSNR and 2) amplitude of that an optical signal would experience had it been transmitted over the amplified fiber link that is being simulated by said simulation.

24. An amplified fiber link simulator that simulates the decrease in OSNR that an optical signal would experience had it been transmitted over the amplified fiber link that is being simulated by said simulation.

25. A method of testing the performance of a forward error correction (FEC) code, the method comprising the steps of:
adding noise having a prescribed spectrum and power level to a FEC coded input optical signal to be tested; and
measuring the bit error rate (BER) of an information signal carried by said input optical signal combined with said noise after performance of FEC correction to extract said information signal.

26. The method of claim 25 further comprising the step of determining a reduction, if any, of the BER resulting from employing said FEC code as compared to not employing said FEC code under the same conditions.
